(19) United States
(12) Patent Application Publication
(10) Pub. No.: US 2007/0185886 A1
(43) Pub. Date: Aug. 9, 2007

(54) Development of progressive disclosure applications

(76) Inventors: Ilja Fischer, Heidelberg (DE); Juergen Schmerder, Wiesloch (DE)

Correspondence Address: KENYON & KENYON LLP, RIVERPARK TOWERS, SUITE 600, 333 W. SAN CARLOS ST., SAN JOSE, CA, 95110, US

(21) Appl. No.: 11/319,512

(22) Filed: Dec. 29, 2005

(51) Int. Cl. G06F 7/00

(52) U.S. Cl. 707/100

(57) ABSTRACT

A system and method for manipulating the fields of a business object using a model is disclosed. A configuration file has a first model to facilitate management of a first set of fields of a business object during runtime. The configuration file has a second model to facilitate management of a second set of aspects of a business object during runtime.

### BACKGROUND

The present invention relates to a system for working with business objects and, in particular, using floorplans to manage the fields of a business object.

Large software applications are often composed of unmanageably large amounts of executable code. In order to facilitate creation and management of large software systems, then, the systems are often composed of many different business objects. Business objects are software components that encompass user interfaces, data, business rules, communication components and any other code that may relate to their function.

In order to simplify design of these large systems, business objects are often defined as collections of logically related functions and data. A large application designed to facilitate a typical business may have many different business objects. An ordering business object may be used to handle incoming orders or changes to existing orders. A shipping business object may be implemented to handle all shipping related tasks, such as arranging for deliveries or determining shipping times and costs. Business objects may handle some tasks independently while communicating with other business objects to complete other tasks.

FIG. 1 illustrates in a block diagram one system 100 for manipulating business objects. A system may have a set of business objects 110, each business object having a number of fields 1-n 120. Each field 120 represents at least one data value 125 and at least one action 130 stored in the business object 110. Each field 120 may have a respective relation 130 indicating how it interacts with other respective fields 120 of the business objects 110. A user may view the field 120 using a portal page 140. When a portal page 140 is opened, that business object 110 is locked to prevent a second user from manipulating the business object as it is being manipulated by the first user.

What is needed is a method of being able to switch from a first program instance for manipulating the fields of a business object to a second program instance without having to exit the first program instance.

### BRIEF DESCRIPTION OF THE DRAWINGS

FIG. 1 illustrates in a block diagram one system for manipulating business objects.

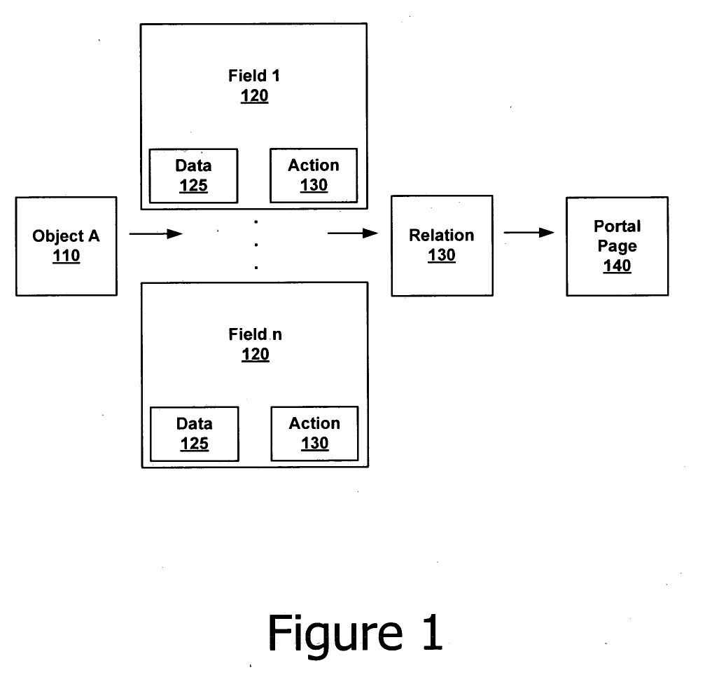

FIG. 2 illustrates a possible configuration of a computer system to implement the application components under the present invention.

FIG. 3 illustrates one embodiment for a system to manipulate the fields of business objects.

FIG. 4 illustrates in a flowchart one embodiment of a method for manipulating the fields of business objects.

FIG. 5 illustrates one embodiment for a system to manipulate the fields of business objects under the present invention.

FIG. 6 illustrates in a flowchart one embodiment of a method for manipulating the fields of business objects 302 under the present invention.

### DETAILED DESCRIPTION

A system and method for manipulating the fields of a business object using a model is disclosed. A configuration file has a first model to facilitate management of a first set of fields of a business object during runtime. The configuration file has a second model to facilitate management of a second set of aspects of a business object during runtime.

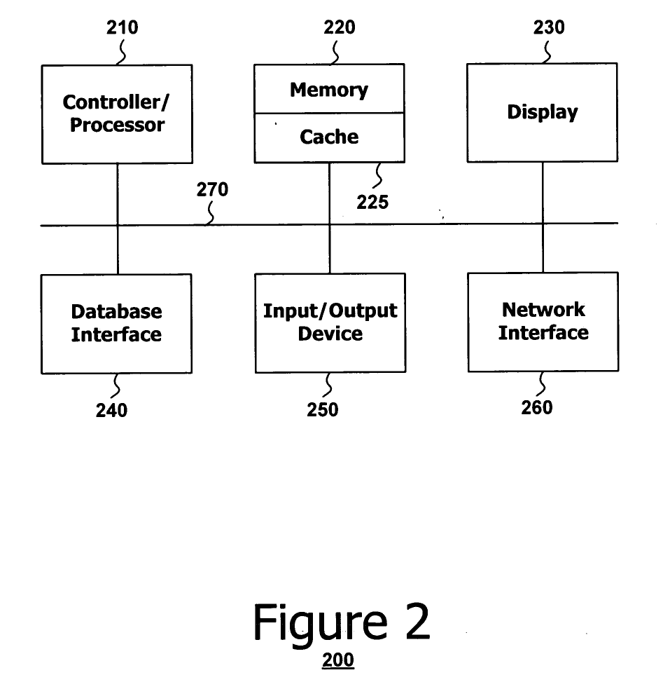

FIG. 2 illustrates a possible configuration of a computer system 200 to implement application components under the present invention. The computer system 200 may include a controller/processor 210, a memory 220 with a cache 225, display 230, database interface 240, input/output device interface 250, and network interface 260, connected through bus 270.

The controller/processor 210 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 220 may include volatile and nonvolatile data storage, including one or more electrical, magnetic or optical memories such as a RAM, cache, hard drive, CD-ROM drive, tape drive or removable storage disk. The memory may have a cache 225 to speed access to specific data.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The network interface 260 may be connected to a communication device, modem, network interface card, a transceiver, or any other device capable of transmitting and receiving signals over a network. The components of the computer system 200 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The computer system 200 may implement any operating system, such as Windows or UNIX, for example. Client and server software may be written in any programming language, such as ABAP, C, C++, Java or Visual Basic, for example.

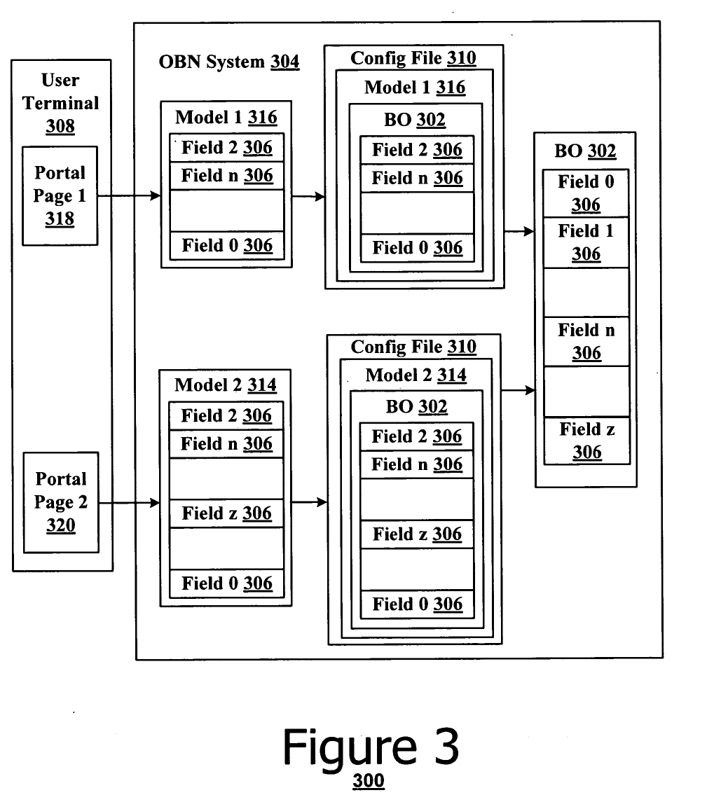

FIG. 3 illustrates one embodiment for a system 300 to manipulate the fields of business objects. A set of one or more business objects 302 may be stored on an object based navigation (OBN) system 304. The fields 306 of the business object 302 may be accessed by a user terminal 308 using a model, such as a model or floorplan. A floorplan may be generated from a configuration file 310, specifying which fields 306 are available to be manipulated by the user. These manipulations may include entry of data into a field 306, editing a field 306, or other actions. Various types of floorplans may be used. For example, floorplan, e.g., Model 1 316 may allow access to only the most often used fields 306 of a business object 302. By focusing on a smaller percentage of the fields, the usability is improved. In addition, the runtime efficiency may be greatly increased. Another type of floorplan, e.g., Model 2 314 may allow access to most or all of the fields 306 of the business object 302. One may also implement a guide, e.g., via the configuration file 310, to facilitate the manipulation of the fields 306 of the business objects 302. The guide may specify the chronological order in which the fields 306 are manipulated. As each configuration file 310 contains a single floorplan or model, a user may create a first portal page 318 to access the business objects 302. To access a field 302 that is not a part of Model 1 316, the first portal page 318 should be closed and a second portal page 320 may be opened to generate a Model 2 314 containing that field 302.

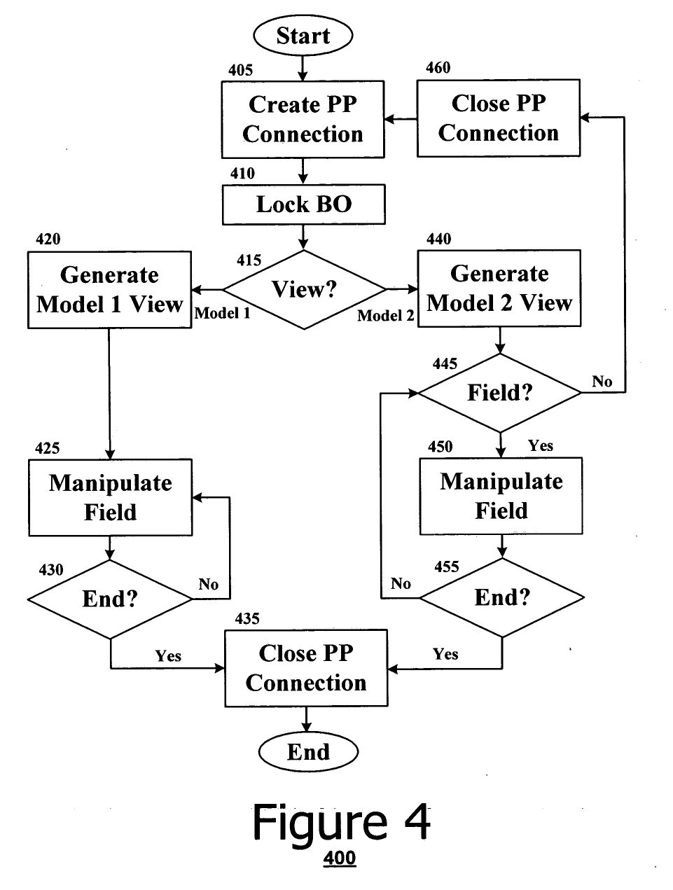

FIG. 4 illustrates in a flowchart one embodiment of a method 400 for manipulating the fields 304 of business objects 302. The user terminal 308 may create a portal page connection with the OBN system 304 (Block 405). The OBN system 304 may lock the business object (BO) 302 (Block 410). If the user selects a first floorplan view (Block 415), the OBN system may generate a Model 1 view (Block 420). The user may manipulate the fields 306 (Block 425), until the session is completed (Block 430). The portal page connection may be closed at that time (Block 435). If the user selects a second view (Block 415), the OBN system may generate a Model 2 view (Block 440). If the fields 306 to be entered are present in the floorplan 312 (Block 445), the user may manipulate the fields 306 (Block 450), until the session is completed (Block 455). The portal page connection may be closed at that time (Block 435). If the fields 306 to be entered are not present in the floorplan 312 (Block 445), the portal page connection may be closed at that time (Block 460), and a new portal page connection created to generate a new floorplan 314 (Block 405).

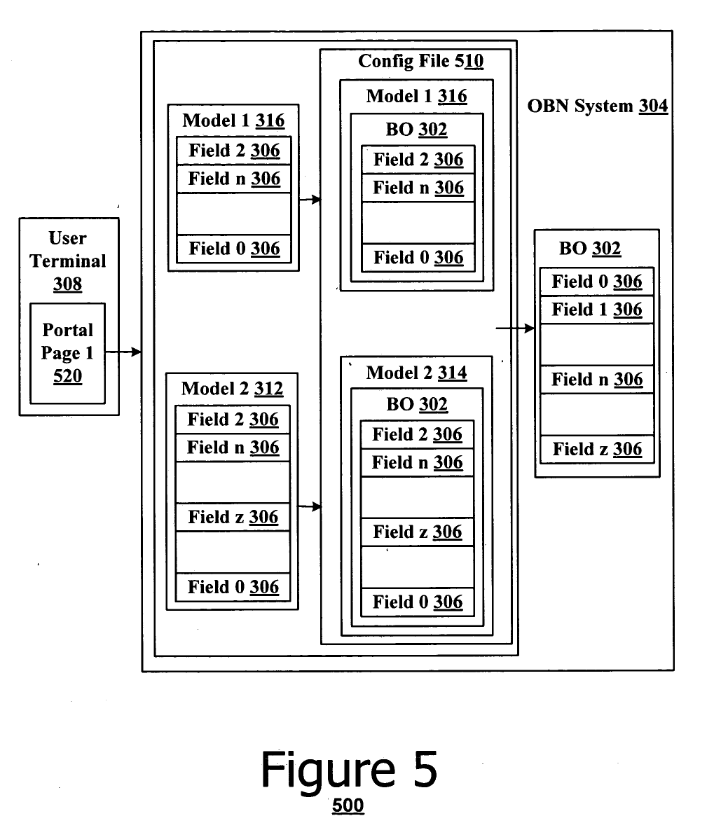

FIG. 5 illustrates one embodiment for a system 500 to manipulate the fields of business objects under the present invention. Multiple floorplans may be generated from a single configuration file 510, specifying which fields 306 are available to be manipulated by the user. Various types of floorplans may be stored in the configuration file 510. Each floorplan may be accessed using a single portal page 520.

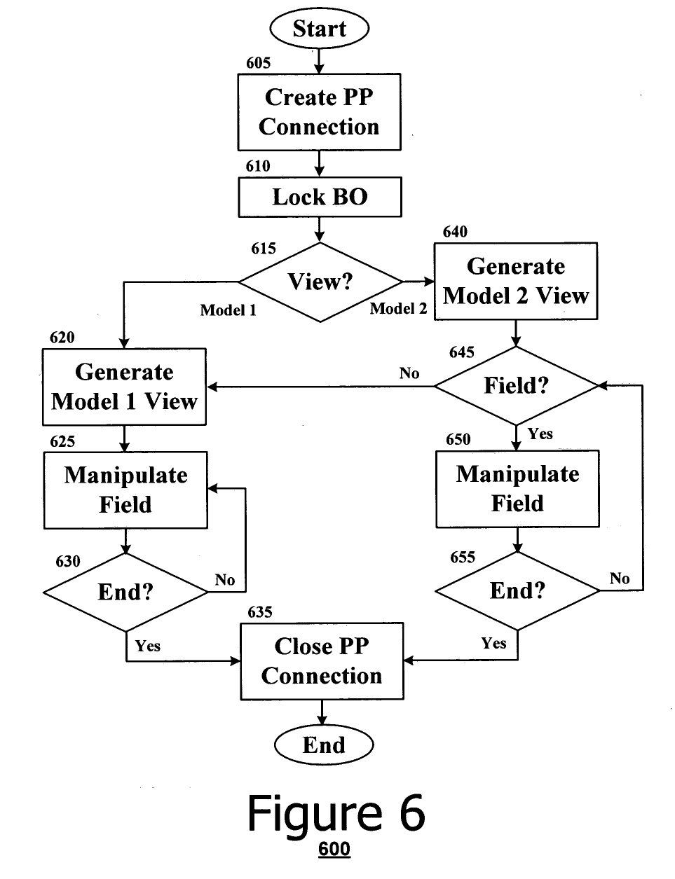

FIG. 6 illustrates in a flowchart one embodiment of a method 600 for manipulating the fields 304 of business objects 302 under the present invention. The user terminal 308 may create a portal page connection with the OBN system 304 (Block 605). The OBN system 304 may lock the business object (BO) 302 (Block 610). If the user selects a Model 1 view (Block 615), the OBN system may generate an Model 1 view (Block 620). The user may manipulate the fields 306 (Block 625), until the session is completed (Block 630). The portal page connection may be closed at that time (Block 635). If the user selects a Model 2 view (Block 615), the OBN system may generate a Model 2 view (Block 640). If the fields 306 to be entered are present in the floorplan 312 (Block 645), the user may manipulate the fields 306 (Block 650), until the session is completed (Block 655). The portal page connection may be closed at that time (Block 635). If the fields 306 to be entered are not present in the floorplan 312 (Block 645), the OBN system 304 may generate another model view (Block 620).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. In a computer system, a method comprising:
creating in a configuration file a first model to facilitate management of a first set of fields of a business object during runtime; and
creating in the configuration file a second model to facilitate management of a second set of aspects of a business object during runtime.

2. The method of claim 1, wherein the first set of fields is a subset of the second set of fields.

3. The method of claim 1, wherein the second set of fields encompasses every field of the business object.

4. The method of claim 1, further comprising creating a guide model to specify an order of entry for the first set of fields.

5. The method of claim 1, further comprising:
creating a connection to the business object using a first portal page; and
generating a first view using the first model.

6. The method of claim 5, further comprising generating a second view using the second model.

7. The method of claim 5, further comprising locking the business object.

8. Computer readable medium storing a set of program instructions that, when executed by a client device, cause the client device to:
creating in a configuration file a first model to facilitate management of a first set of fields of a business object during runtime; and
creating in the configuration file a second model to facilitate management of a second set of aspects of a business object during runtime.

9. The set of program instructions of claim 8, wherein the first set of data fields is a subset of the second set of data fields.

10. The set of program instructions of claim 8, wherein the second set of fields encompasses every data field in the business object.

11. The set of program instructions of claim 8, further comprising creating a guide model to specify an order of entry for the first set of data fields.

12. The set of program instructions of claim 8, further comprising:
creating a connection to the business object using a first portal page; and
generating a first view using the first model.

13. The set of program instructions of claim 12, further comprising generating a second view using the second model.

14. The set of program instructions of claim 12, further comprising locking the business object.

15. A business object navigation system comprising:
a data storage medium to store a configuration file to generate a first model to facilitate management of a first set of fields of a business object during runtime and a second model to facilitate management of a second set of aspects of a business object during runtime; and
a processor to generate a view of the first model.

16. The business object navigation system of claim 15, wherein the first set of data fields is a subset of the second set of data fields.

17. The business object navigation system of claim 15, wherein the second set of fields encompasses every data field in the business object.

18. The business object navigation system of claim 15, wherein the configuration file has a guide model to specify an order of entry for the first set of data fields.

19. The business object navigation system of claim 15, further comprising a first portal page to connect to the business object.

20. The business object navigation system of claim 15, wherein the processor generates a second view using the second model.
